(19) United States
(12) Patent Application Publication
(10) Pub. No.: US 2025/0117056 A1
(43) Pub. Date: Apr. 10, 2025

(54) THERMAL MANAGEMENT IN DISPLAY SYSTEMS

(71) Applicant: Meta Platforms Technologies, LLC, Menlo Park, CA (US)

(72) Inventors: Shenghui LEI, Castleknock (IE); Chau Van HO, Des Moines, WA (US); Dusan COSO, Bothell, WA (US)

(21) Appl. No.: 18/906,131

(22) Filed: Oct. 3, 2024

Related U.S. Application Data
(60) Provisional application No. 63/588,266, filed on Oct. 5, 2023.

(51) Int. Cl. G06F 1/20; C09K 5/06

(52) U.S. Cl. CPC G06F 1/206; C09K 5/063

(57) ABSTRACT

Thermal management in a display system can be implemented using at least one temperature regulating element (TRE). The display system can include an array of light emitting diodes or some other type of light emitter. Each light emitter of the array includes an active region configured to emit light and can be formed from a shared semiconductor structure in which the at least one TRE is located. Each TRE includes a phase change material configured to undergo a phase transition from a first state of matter to a second state of matter in response to heat, such that at least some of the heat is expended in causing the phase transition instead of heating an area around the TRE. In this manner, the at least one TRE can operate as a passive cooling solution for regulating the temperatures of the light emitters.

### CROSS-REFERENCE TO RELATED APPLICATIONS

This application claims the benefit of U.S. Provisional Application No. 63/588,266, filed Oct. 5, 2023, entitled “THERMAL MANAGEMENT IN DISPLAY SYSTEMS” which is incorporated herein by reference in its entirety.

### BACKGROUND

An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

Display systems generally include light emitters that are electronically controllable to display images. For example, in some artificial reality systems, images may be presented to users using a light emitting diode (LED) based display subsystem. The LEDs in an artificial reality system can be micro-LEDs, which typically have a lateral dimension (e.g., pixel width) of less than 10 microns. Other types of light emitters, such as a vertical-cavity surface-emitting laser (VCSEL), can also be used to form a display system for artificial reality applications. The performance characteristics of light emitters can be influenced by operating temperature. For instance, micro-LEDs and laser-based emitters tend to be sensitive to the junction temperature in the active (light-emitting) region of the emitter. Operating temperature may increase as a result of heat generated in the active region when an emitter is activated to emit light. Changes in operating temperature may also arise from external factors such as heat produced by neighboring light emitters or other electronics. In the absence of temperature regulation or other thermal management strategies, operating temperature change can be detrimental to emitter performance. For example, an increase in operating temperature can shift the wavelength of the emitted light. Further, prolonged operation at high temperatures can damage the emitters, leading to burn-in (image retention) or other display issues.

### SUMMARY

This disclosure relates generally to thermal management in display systems. In particular, aspects of the disclosure are directed to temperature regulation for displays in artificial reality systems. Because artificial reality systems are usually viewed up close, temperature induced changes in display performance tend to be very noticeable. Thermal management can be applied to provide a better viewing experience to users of artificial reality systems. For example, temperature regulation can reduce or minimize wavelength shifts caused by increased operating temperature so that image quality is maintained (e.g., less image distortion). This also has the effect of maintaining the energy conversion efficiency of the light emitters in the display system, known as wall-plug efficiency (WPE) or radiant efficiency, since wavelength shifts (e.g., an increase in the wavelength of emitted light) can reduce WPE.

Example embodiments are described in which temperature regulation is achieved through incorporating a phase change material (PCM) into the display system as a passive cooling solution. A PCM is a substance that undergoes a phase transition (e.g., from solid to liquid or vice versa) in response to heating or cooling. The phase transition is associated with release or absorption of energy, causing the PCM to enter a higher or lower energy state compared to the initial energy state of the PCM. For example, sodium acetate is sometimes used to make hand warmers. Sodium acetate can be dissolved in water through heating to form a supersaturated solution (sodium acetate hydrate) that undergoes crystallization to release heat. Sodium acetate hydrate is an example of a PCM that relies on a nucleating agent (e.g., a metal disc) to initiate crystal formation. PCMs also exist which do not require nucleating agents.

Thus, a PCM can be configured to “store” and subsequently release heat that would otherwise contribute to an increase in operating temperature. PCM can be applied to select locations in a display system in order to dissipate heat and maintain a more consistent operating temperature for the light emitters of the display system. In addition to providing localized thermal management, the PCM can be applied to reduce or minimize thermal crosstalk between heat generating elements such as neighboring LEDs. Temperature regulating elements that contain PCM are passive elements that do not require electrical power. PCM also has benefits over conventional passive cooling solutions. For example, heat sinks are designed to draw heat away from a heat source (e.g., through a set of metal fins), but heat sinks are bulky and usually dissipate heat directly into the ambient environment. If the display system is enclosed in a device housing, the device can quickly become uncomfortably hot as heat radiates from the heat sink and warms the air inside the housing. For this reason, heat sinks are often coupled with active cooling components such as a motorized fan to direct hot air out of the device.

Implementations of the thermal management techniques disclosed herein may include one or more of the following features. A display system with one or more temperature regulating elements formed using a PCM or combination of different phase change materials, where the PCM is configured to undergo a phase transition in response to heat, such that at least some of the heat is used to trigger the phase transition instead of being transferred to a nearby light emitter(s). The temperature at which the phase transition occurs can be controlled through selection of an appropriate phase change material(s). The PCM can be configured to have a phase transition temperature within an expected operating temperature range of the display system. The phase transition temperature can be approximately equal to a target operating temperature to be maintained. The PCM can further be configured to undergo a reverse phase transition in response to cooling (e.g., when the display system is turned off), such that the PCM releases stored energy in the form of heat. The reverse phase transition may be initiated automatically sometime after the light emitters are deactivated or once a heat source is no longer actively producing heat.

In some embodiments, an apparatus includes a semiconductor structure having a plurality of light emitters formed therefrom. Each light emitter includes an active region configured to emit light. The apparatus further includes at least one temperature regulating element (TRE) in the semiconductor structure. Each TRE includes a phase change material configured to undergo a phase transition from a first state of matter to a second state of matter in response to heat, such that at least some of the heat is expended in causing the phase transition instead of heating an area around the TRE.

In some embodiments, a display system includes an LED array, a driver circuit, and at least one TRE. The LED array includes a plurality of LEDs formed from a semiconductor structure. The semiconductor structure includes an active layer corresponding to a light emitting region of each LED. The driver circuit is configured to control the LED array using electrical signals communicated through the semiconductor structure. The at least one TRE is in the semiconductor structure. Each TRE includes a phase change material configured to undergo a phase transition from a first state of matter to a second state of matter in response to heat, such that at least some of the heat is expended in causing the phase transition instead of heating an area around the TRE. The heat causing the phase transition originates at least in part from the light emitting region of one or more LEDs that are activated by the driver circuit.

This summary is neither intended to identify key or essential features of the claimed subject matter nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified block diagram of an example of an artificial reality system environment in which one or more disclosed embodiments may be implemented.

FIG. 2 is a perspective view of an example of a near-eye display system in the form of a head-mounted display (HMD) device for implementing one or more disclosed embodiments.

FIG. 3 is a perspective view of an example of a near-eye display system in the form of a pair of glasses for implementing one or more disclosed embodiments.

FIGS. 4A and 4B illustrate examples of light emitting diode (LEDs) with different mesa structures.

FIG. 5 illustrates an example of an LED device with temperature regulating elements (TREs), according to certain embodiments.

FIG. 6 illustrates another example of an LED device with TREs, according to certain embodiments.

FIGS. 7A to 7C illustrate an example of a process for forming TREs in an LED device, according to certain embodiments.

FIGS. 8A to 8C illustrate another example of a process for forming TREs in an LED device, according to certain embodiments.

FIGS. 9A to 9C illustrate examples of different ways in which TREs may be arranged, according to certain embodiments.

FIG. 10A is a graph of junction temperature and wavelength in the absence of thermal management.

FIG. 10B is a graph of junction temperature and wavelength after applying the thermal management techniques disclosed herein.

FIG. 11 is a simplified block diagram of an example of an electronic system of a near-eye display system (e.g., HMD device) for implementing some of the examples disclosed herein according to certain embodiments.

### DETAILED DESCRIPTION

Techniques disclosed herein relate generally to thermal management in display systems. In particular, aspects of the disclosure are directed to thermal management in artificial reality systems, through incorporating temperature regulating elements (TREs) into a display device. Examples are described with respect to LED devices. However, the thermal management techniques disclosed herein can be applied to other display technologies including, for example, laser-based emitters. In some embodiments, a TRE may include one or more phase change materials (PCMs) such that the TRE undergoes a phase transition to absorb or release heat produced by a heat source (e.g., one or more LEDs) near the TRE. Consequently, the TRE can be configured to convert the heat from the heat source into stored energy. Further, the TRE can be configured to undergo a reverse phase transition when the display device has cooled down sufficiently. The PCM may have a large storage capacity, and the reverse phase transition can occur over a period of time to release heat in a gradual, controlled manner so that the display device is not subjected to large temperature swings. Consequently, the display device can be operated at a relatively steady temperature, making the display device essentially athermal from an optical performance standpoint. For example, the TRE(s) may enable the display device to maintain a narrow range of operating temperatures so that the wavelengths of light emitted by individual LEDs, and therefore the wall-plug efficiency (WPE) of the LEDs, are held substantially constant even after hours of continuous operation.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

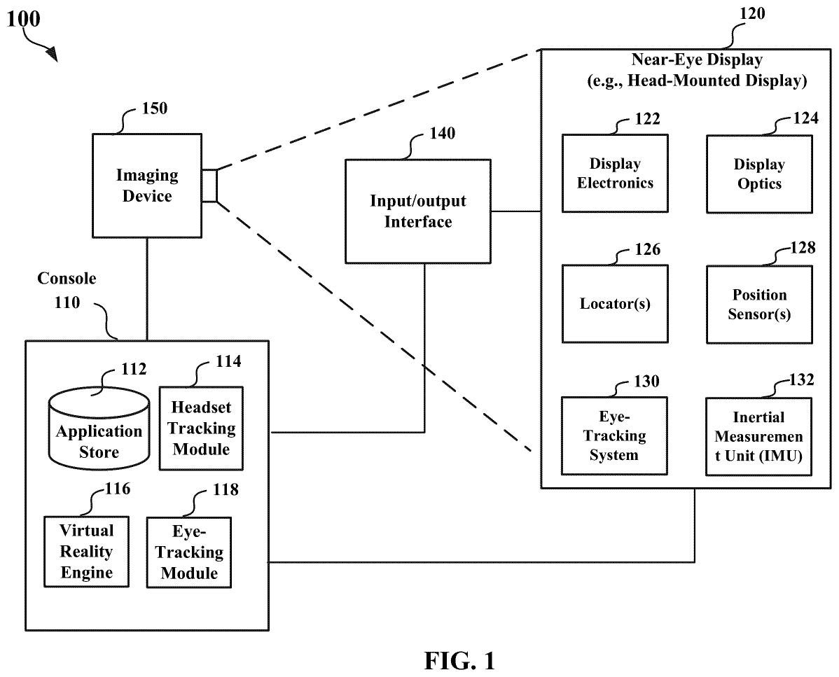

FIG. 1 is a simplified block diagram of an example of an artificial reality system environment 100 including a near-eye display system 120 in accordance with certain embodiments. Artificial reality system environment 100 shown in FIG. 1 may include near-eye display system 120, an optional imaging device 150, and an optional input/output interface 140 that may each be coupled to an optional console 110. While FIG. 1 shows example artificial reality system environment 100 including one near-eye display system 120, one imaging device 150, and one input/output interface 140, any number of these components may be included in artificial reality system environment 100, or any of the components may be omitted. For example, there may be multiple near-eye display systems 120 monitored by one or more external imaging devices 150 in communication with console 110. In some configurations, artificial reality system environment 100 may not include imaging device 150, optional input/output interface 140, and optional console 110. In alternative configurations, different or additional components may be included in artificial reality system environment 100. In some configurations, near-eye display systems 120 may include imaging device 150, which may be used to track one or more input/output devices (e.g., input/output interface 140), such as a handhold controller.

Near-eye display system 120 may be a head-mounted display that presents content to a user. Examples of content presented by near-eye display system 120 include one or more of images, videos, audios, or some combination thereof. In some embodiments, audios may be presented via an external device (e.g., speakers and/or headphones) that receives audio information from near-eye display system 120, console 110, or both, and presents audio data based on the audio information. Near-eye display system 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display system 120 may be implemented in any suitable form factor, including a pair of glasses. Some embodiments of near-eye display system 120 are further described below. Additionally, in various embodiments, the functionality described herein may be used in a headset that combines images of an environment external to near-eye display system 120 and artificial reality content (e.g., computer-generated images). Therefore, near-eye display system 120 may augment images of a physical, real-world environment external to near-eye display system 120 with generated content (e.g., images, video, sound, etc.) to present an augmented reality to a user.

In various embodiments, near-eye display system 120 may include one or more of display electronics 122, display optics 124, and an eye-tracking system 130. In some embodiments, near-eye display system 120 may also include one or more locators 126, one or more position sensors 128, and an inertial measurement unit (IMU) 132. Near-eye display system 120 may omit any of these elements or include additional elements in various embodiments. Additionally, in some embodiments, near-eye display system 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (micro-LED or pLED) display, an active-matrix OLED display (AMOLED), a transparent OLED display (TOLED), or some other display. For example, in one implementation of near-eye display system 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereo effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers), magnify image light received from display electronics 122, correct optical errors associated with the image light, and present the corrected image light to a user of near-eye display system 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an anti-reflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display system 120.

Display optics 124 may also be designed to correct one or more types of optical errors, such as two-dimensional optical errors, three-dimensional optical errors, or a combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display system 120 relative to one another and relative to a reference point on near-eye display system 120. In some implementations, console 110 may identify locators 126 in images captured by imaging device 150 to determine the artificial reality headset's position, orientation, or both. A locator 126 may be a light emitting diode (LED), a corner cube reflector, a reflective marker, a type of light source that contrasts with an environment in which near-eye display system 120 operates, or some combinations thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

Imaging device 150 may be part of near-eye display system 120 or may be external to near-eye display system 120. Imaging device 150 may generate slow calibration data based on calibration parameters received from console 110. Slow calibration data may include one or more images showing observed positions of locators 126 that are detectable by imaging device 150. Imaging device 150 may include one or more cameras, one or more video cameras, any other device capable of capturing images including one or more of locators 126, or some combinations thereof. Additionally, imaging device 150 may include one or more filters (e.g., to increase signal to noise ratio). Imaging device 150 may be configured to detect light emitted or reflected from locators 126 in a field of view of imaging device 150. In embodiments where locators 126 include passive elements (e.g., retroreflectors), imaging device 150 may include a light source that illuminates some or all of locators 126, which may retro-reflect the light to the light source in imaging device 150. Slow calibration data may be communicated from imaging device 150 to console 110, and imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display system 120. Examples of position sensors 128 may include accelerometers, gyroscopes, magnetometers, other motion-detecting or error-correcting sensors, or some combinations thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or some combination thereof. Based on the one or more measurement signals from one or more position sensors 128, IMU 132 may generate fast calibration data indicating an estimated position of near-eye display system 120 relative to an initial position of near-eye display system 120. For example, IMU 132 may integrate measurement signals received from accelerometers over time to estimate a velocity vector and integrate the velocity vector over time to determine an estimated position of a reference point on near-eye display system 120. Alternatively, IMU 132 may provide the sampled measurement signals to console 110, which may determine the fast calibration data. While the reference point may generally be defined as a point in space, in various embodiments, the reference point may also be defined as a point within near-eye display system 120 (e.g., a center of IMU 132).

Eye-tracking system 130 may include one or more eye-tracking systems. Eye tracking may refer to determining an eye's position, including orientation and location of the eye, relative to near-eye display system 120. An eye-tracking system may include an imaging system to image one or more eyes and may generally include a light emitter, which may generate light that is directed to an eye such that light reflected by the eye may be captured by the imaging system. For example, eye-tracking system 130 may include a non-coherent or coherent light source (e.g., a laser diode) emitting light in the visible spectrum or infrared spectrum, and a camera capturing the light reflected by the user's eye. As another example, eye-tracking system 130 may capture reflected radio waves emitted by a miniature radar unit. Eye-tracking system 130 may use low-power light emitters that emit light at frequencies and intensities that would not injure the eye or cause physical discomfort. Eye-tracking system 130 may be arranged to increase contrast in images of an eye captured by eye-tracking system 130 while reducing the overall power consumed by eye-tracking system 130 (e.g., reducing power consumed by a light emitter and an imaging system included in eye-tracking system 130). For example, in some implementations, eye-tracking system 130 may consume less than 100 milliwatts of power.

Eye-tracking system 130 may be configured to estimate the orientation of the user's eye. The orientation of the eye may correspond to the direction of the user's gaze within near-eye display system 120. The orientation of the user's eye may be defined as the direction of the foveal axis, which is the axis between the fovea (an area on the retina of the eye with the highest concentration of photoreceptors) and the center of the eye's pupil. In general, when a user's eyes are fixed on a point, the foveal axes of the user's eyes intersect that point. The pupillary axis of an eye may be defined as the axis that passes through the center of the pupil and is perpendicular to the corneal surface. In general, even though the pupillary axis and the foveal axis intersect at the center of the pupil, the pupillary axis may not directly align with the foveal axis. For example, the orientation of the foveal axis may be offset from the pupillary axis by approximately −1° to 8° laterally and about ±4° vertically (which may be referred to as kappa angles, which may vary from person to person). Because the foveal axis is defined according to the fovea, which is located in the back of the eye, the foveal axis may be difficult or impossible to measure directly in some eye-tracking embodiments. Accordingly, in some embodiments, the orientation of the pupillary axis may be detected and the foveal axis may be estimated based on the detected pupillary axis.

In general, the movement of an eye corresponds not only to an angular rotation of the eye, but also to a translation of the eye, a change in the torsion of the eye, and/or a change in the shape of the eye. Eye-tracking system 130 may also be configured to detect the translation of the eye, which may be a change in the position of the eye relative to the eye socket. In some embodiments, the translation of the eye may not be detected directly, but may be approximated based on a mapping from a detected angular orientation. Translation of the eye corresponding to a change in the eye's position relative to the eye-tracking system due to, for example, a shift in the position of near-eye display system 120 on a user's head, may also be detected. Eye-tracking system 130 may also detect the torsion of the eye and the rotation of the eye about the pupillary axis. Eye-tracking system 130 may use the detected torsion of the eye to estimate the orientation of the foveal axis from the pupillary axis. In some embodiments, eye-tracking system 130 may also track a change in the shape of the eye, which may be approximated as a skew or scaling linear transform or a twisting distortion (e.g., due to torsional deformation). In some embodiments, eye-tracking system 130 may estimate the foveal axis based on some combinations of the angular orientation of the pupillary axis, the translation of the eye, the torsion of the eye, and the current shape of the eye.

In some embodiments, eye-tracking system 130 may include multiple emitters or at least one emitter that can project a structured light pattern on all portions or a portion of the eye. The structured light pattern may be distorted due to the shape of the eye when viewed from an offset angle. Eye-tracking system 130 may also include at least one camera that may detect the distortions (if any) of the structured light pattern projected onto the eye. The camera may be oriented on a different axis to the eye than the emitter. By detecting the deformation of the structured light pattern on the surface of the eye, eye-tracking system 130 may determine the shape of the portion of the eye being illuminated by the structured light pattern. Therefore, the captured distorted light pattern may be indicative of the 3D shape of the illuminated portion of the eye. The orientation of the eye may thus be derived from the 3D shape of the illuminated portion of the eye. Eye-tracking system 130 can also estimate the pupillary axis, the translation of the eye, the torsion of the eye, and the current shape of the eye based on the image of the distorted structured light pattern captured by the camera.

Near-eye display system 120 may use the orientation of the eye to, e.g., determine an inter-pupillary distance (IPD) of the user, determine gaze directions, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or some combination thereof. Because the orientation may be determined for both eyes of the user, eye-tracking system 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, imaging device 150 may be used to track input/output interface 140, such as tracking the location or position of a controller (which may include, for example, an IR light source) or a hand of the user to determine the motion of the user. In some embodiments, near-eye display 120 may include one or more imaging devices (e.g., imaging device 150) to track input/output interface 140, such as tracking the location or position of a controller or a hand of the user to determine the motion of the user.

Console 110 may provide content to near-eye display system 120 for presentation to the user in accordance with information received from one or more of imaging device 150, near-eye display system 120, and input/output interface 140. In the example shown in FIG. 1, console 110 may include an application store 112, a headset tracking module 114, an artificial reality engine 116, and eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display system 120 using slow calibration information from imaging device 150. For example, headset tracking module 114 may determine positions of a reference point of near-eye display system 120 using observed locators from the slow calibration information and a model of near-eye display system 120. Headset tracking module 114 may also determine positions of a reference point of near-eye display system 120 using position information from the fast calibration information. Additionally, in some embodiments, headset tracking module 114 may use portions of the fast calibration information, the slow calibration information, or some combination thereof, to predict a future location of near-eye display system 120. Headset tracking module 114 may provide the estimated or predicted future position of near-eye display system 120 to artificial reality engine 116.

Headset tracking module 114 may calibrate the artificial reality system environment 100 using one or more calibration parameters, and may adjust one or more calibration parameters to reduce errors in determining the position of near-eye display system 120. For example, headset tracking module 114 may adjust the focus of imaging device 150 to obtain a more accurate position for observed locators on near-eye display system 120. Moreover, calibration performed by headset tracking module 114 may also account for information received from IMU 132. Additionally, if tracking of near-eye display system 120 is lost (e.g., imaging device 150 loses line of sight of at least a threshold number of locators 126), headset tracking module 114 may re-calibrate some or all of the calibration parameters.

Artificial reality engine 116 may execute applications within artificial reality system environment 100 and receive position information of near-eye display system 120, acceleration information of near-eye display system 120, velocity information of near-eye display system 120, predicted future positions of near-eye display system 120, or some combination thereof from headset tracking module 114. Artificial reality engine 116 may also receive estimated eye position and orientation information from eye-tracking module 118. Based on the received information, artificial reality engine 116 may determine content to provide to near-eye display system 120 for presentation to the user. For example, if the received information indicates that the user has looked to the left, artificial reality engine 116 may generate content for near-eye display system 120 that reflects the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display system 120 or haptic feedback via input/output interface 140.

Eye-tracking module 118 may receive eye-tracking data from eye-tracking system 130 and determine the position of the user's eye based on the eye-tracking data. The position of the eye may include an eye's orientation, location, or both relative to near-eye display system 120 or any element thereof. Because the eye's axes of rotation change as a function of the eye's location in its socket, determining the eye's location in its socket may allow eye-tracking module 118 to more accurately determine the eye's orientation.

In some embodiments, eye-tracking module 118 may store a mapping between images captured by eye-tracking system 130 and eye positions to determine a reference eye position from an image captured by eye-tracking system 130. Alternatively or additionally, eye-tracking module 118 may determine an updated eye position relative to a reference eye position by comparing an image from which the reference eye position is determined to an image from which the updated eye position is to be determined. Eye-tracking module 118 may determine eye position using measurements from different imaging devices or other sensors. For example, eye-tracking module 118 may use measurements from a slow eye-tracking system to determine a reference eye position, and then determine updated positions relative to the reference eye position from a fast eye-tracking system until a next reference eye position is determined based on measurements from the slow eye-tracking system.

Eye-tracking module 118 may also determine eye calibration parameters to improve precision and accuracy of eye tracking. Eye calibration parameters may include parameters that may change whenever a user dons or adjusts near-eye display system 120. Example eye calibration parameters may include an estimated distance between a component of eye-tracking system 130 and one or more parts of the eye, such as the eye's center, pupil, cornea boundary, or a point on the surface of the eye. Other example eye calibration parameters may be specific to a particular user and may include an estimated average eye radius, an average corneal radius, an average sclera radius, a map of features on the eye surface, and an estimated eye surface contour. In embodiments where light from the outside of near-eye display system 120 may reach the eye (as in some augmented reality applications), the calibration parameters may include correction factors for intensity and color balance due to variations in light from the outside of near-eye display system 120. Eye-tracking module 118 may use eye calibration parameters to determine whether the measurements captured by eye-tracking system 130 would allow eye-tracking module 118 to determine an accurate eye position (also referred to herein as “valid measurements”). Invalid measurements, from which eye-tracking module 118 may not be able to determine an accurate eye position, may be caused by the user blinking, adjusting the headset, or removing the headset, and/or may be caused by near-eye display system 120 experiencing greater than a threshold change in illumination due to external light. In some embodiments, at least some of the functions of eye-tracking module 118 may be performed by eye-tracking system 130.

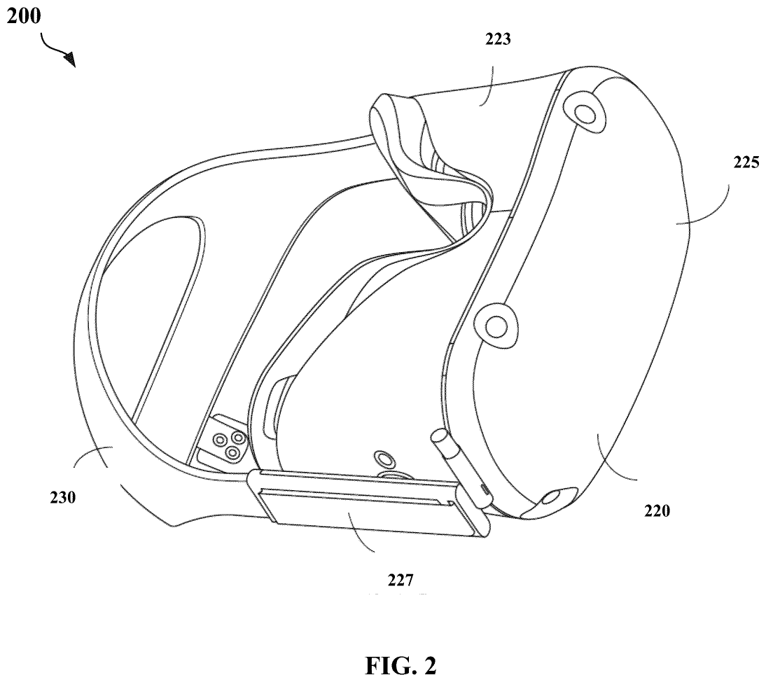

FIG. 2 is a perspective view of an example of a near-eye display system in the form of a head-mounted display (HMD) device 200 for implementing some of the examples disclosed herein. HMD device 200 may be a part of, e.g., a virtual reality (VR) system, an augmented reality (AR) system, a mixed reality (MR) system, or some combinations thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMID device 200 onto the user's head. In various embodiments, HMD device 200 may include additional, fewer, or different components. For example, in some embodiments, HMD device 200 may include eyeglass temples and temples tips as shown in, for example, FIG. 2, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audios, or some combinations thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, a liquid crystal display (LCD), an organic light emitting diode (OLED) display, an inorganic light emitting diode (ILED) display, a micro light emitting diode (micro-LED or pLED) display, an active-matrix organic light emitting diode (AMOLED) display, a transparent organic light emitting diode (TOLED) display, some other display, or some combinations thereof. HMD device 200 may include two eye box regions.

In some implementations, HMD device 200 may include various sensors (not shown), such as depth sensors, motion sensors, position sensors, and eye-tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or some combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

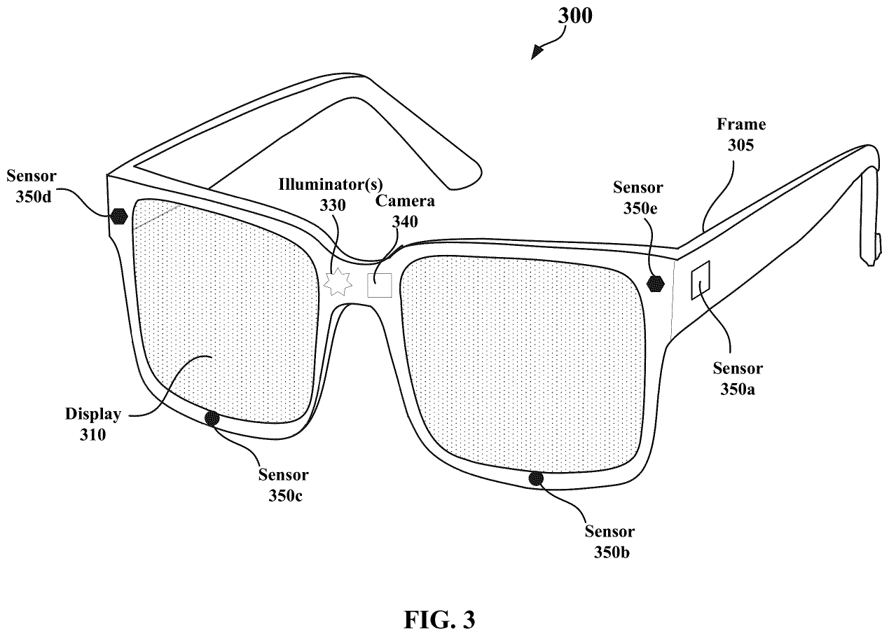

FIG. 3 is a perspective view of an example of a near-eye display system 300 in the form of a pair of glasses for implementing some of the examples disclosed herein. Near-eye display system 300 may be a specific implementation of near-eye display system 120 of FIG. 1, and may be configured to operate as a virtual reality display, an augmented reality display, and/or a mixed reality display. Near-eye display system 300 may include a frame 305 and a display 310. Display 310 may be configured to present content to a user. In some embodiments, display 310 may include display electronics and/or display optics. For example, as described above with respect to near-eye display system 120 of FIG. 1, display 310 may include an LCD display panel, an LED display panel, or an optical display panel (e.g., a waveguide display assembly).

Near-eye display system 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display system 300, and/or to provide an interactive VR/AR/MR experience to a user of near-eye display system 300. In some embodiments, sensors 350a-350e may also be used for stereoscopic imaging.

In some embodiments, near-eye display system 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light pattern onto the objects within the environment. In some embodiments, illuminator(s) 330 may be used as locators, such as locators 126 described above with respect to FIG. 1.

In some embodiments, near-eye display system 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

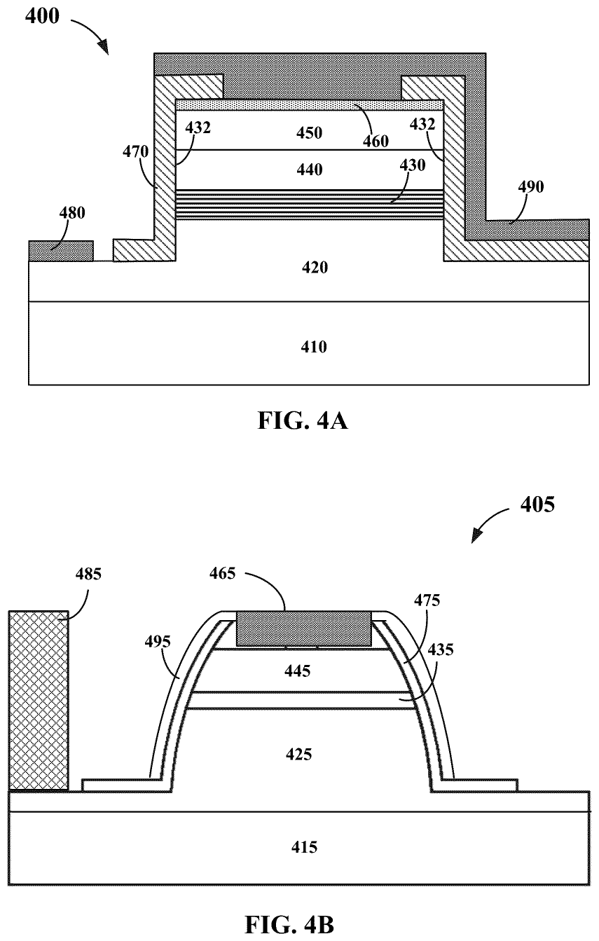

FIG. 4A illustrates an example of an LED 400 usable for forming a display system. In the example of FIG. 4A, the LED 400 has a vertical mesa structure. LED 400 may be a micro-LED having a layered semiconductor structure. The layered semiconductor structure of the LED 400 can include multiple layers of III-V semiconductor materials. A III-V semiconductor material may include one or more Group III elements, such as aluminum (Al), gallium (Ga), or indium (In), in combination with a Group V element, such as nitrogen (N), phosphorus (P), arsenic (As), or antimony (Sb). When the Group V element of the III-V semiconductor material includes nitrogen, the III-V semiconductor material is referred to as a III-nitride material. The layered semiconductor light emitting device may be manufactured by growing multiple epitaxial layers on a substrate using techniques such as vapor-phase epitaxy (VPE), liquid-phase epitaxy (LPE), molecular beam epitaxy (MBE), or metalorganic chemical vapor deposition (MOCVD). For example, the layers of the semiconductor materials may be grown layer-by-layer on a substrate with a certain crystal lattice orientation (e.g., polar, nonpolar, or semi-polar orientation), such as a GaN, GaAs, or GaP substrate, or a substrate including, but not limited to, sapphire, silicon carbide, silicon, zinc oxide, boron nitride, lithium aluminate, lithium niobate, germanium, aluminum nitride, lithium gallate, partially substituted spinels, or quaternary tetragonal oxides sharing the beta-LiAlO₂ structure, where the substrate may be cut in a specific direction to expose a specific plane as the growth surface.

As shown in FIG. 4A, LED 400 may include a substrate 410, which may include, for example, a sapphire substrate or a GaN substrate. A semiconductor layer 420 may be grown on substrate 410. Semiconductor layer 420 may include a III-V material, such as GaN, and may be p-doped (e.g., with Mg, Ca, Zn, or Be) or n-doped (e.g., with Si or Ge). One or more active layers 430 may be grown on semiconductor layer 420 to form an active region. Active layer 430 may include III-V materials, such as one or more InGaN layers, one or more AlInGaP layers, and/or one or more GaN layers, which may form one or more heterostructures, such as one or more quantum wells or multiple quantum wells (MQWs). A semiconductor layer 440 may be grown on active layer 430. Semiconductor layer 440 may include a III-V material, such as GaN, and may be p-doped (e.g., with Mg, Ca, Zn, or Be) or n-doped (e.g., with Si or Ge). One of semiconductor layer 420 and semiconductor layer 440 may be a p-type layer and the other one may be an n-type layer. Semiconductor layer 420 and semiconductor layer 440 sandwich active layer 730 to form the light emitting region. For example, LED 400 may include a layer of InGaN situated between a layer of p-type GaN doped with magnesium and a layer of n-type GaN doped with silicon or oxygen. In some embodiments, LED 400 may include a layer of AlInGaP situated between a layer of p-type AlInGaP doped with zinc or magnesium and a layer of n-type AlInGaP doped with selenium, silicon, or tellurium.

In some embodiments, an electron-blocking layer (EBL) may be grown to form a layer between active layer 430 and at least one of semiconductor layer 420 or semiconductor layer 440. The EBL may reduce the electron leakage current and improve the efficiency of the LED. In some embodiments, a heavily-doped semiconductor layer 450, such as a P⁺ or P⁺⁺ semiconductor layer, may be formed on semiconductor layer 440 and act as a contact layer for forming an ohmic contact and reducing the contact impedance of the device. In some embodiments, a conductive layer 460 may be formed on heavily-doped semiconductor layer 450. Conductive layer 460 may include, for example, an indium tin oxide (ITO) or Al/Ni/Au film. In one example, conductive layer 460 may include a transparent ITO layer.

To make contact with semiconductor layer 420 (e.g., an n-GaN layer) and to more efficiently extract light emitted by active layer 430 from LED 400, the semiconductor material layers (including heavily-doped semiconductor layer 450, semiconductor layer 440, active layer 430, and semiconductor layer 420) may be etched to expose semiconductor layer 420 and to form a mesa structure that includes layers 420-460. The mesa structure may confine the carriers within the device. Etching the mesa structure may lead to the formation of mesa sidewalls 432 that may be orthogonal to the growth planes. A passivation layer 470 may be formed on sidewalls 432 of the mesa structure. Passivation layer 470 may include an oxide layer, such as a SiO₂ layer, and may act as a reflector to reflect emitted light out of LED 400. A contact layer 480, which may include a metal layer, such as Al, Au, Ni, Ti, or any combination thereof, may be formed on semiconductor layer 420 and may act as an electrode of LED 400. In addition, another contact layer 490, such as an Al/Ni/Au metal layer, may be formed on conductive layer 460 and may act as another electrode of LED 400.

When an electrical signal (e.g., a voltage) is applied to contact layers 480 and 490, electrons and holes may recombine in active layer 430, where the recombination of electrons and holes may cause photon emission. The wavelength and energy of the emitted photons may depend on the energy bandgap between the valence band and the conduction band in active layer 430. For example, InGaN active layers may emit green or blue light, AlGaN active layers may emit blue to ultraviolet light, while AlInGaP active layers may emit red, orange, yellow, or green light. The emitted photons may be reflected by passivation layer 470 and may exit LED 400 from the top (e.g., conductive layer 460 and contact layer 490) or bottom (e.g., substrate 410).

In some embodiments, LED 400 may include one or more other components, such as a lens, on the light emission surface, such as substrate 410, to focus or collimate the emitted light or couple the emitted light into a waveguide. In some embodiments, an LED may include a mesa of another shape, such as planar, conical, semi-parabolic, or parabolic, and a base area of the mesa may be circular, rectangular, hexagonal, or triangular. For example, the LED may include a mesa of a curved shape (e.g., paraboloid shape) and/or a non-curved shape (e.g., conic shape). The mesa may be truncated or non-truncated.

FIG. 4B is a cross-sectional view of an example of an LED 405 having a parabolic mesa structure. Similar to LED 400, LED 405 may include multiple layers of semiconductor materials, such as multiple layers of III-V semiconductor materials. The semiconductor material layers may be epitaxially grown on a substrate 415, such as a GaN substrate or a sapphire substrate. For example, a semiconductor layer 425 may be grown on substrate 415. Semiconductor layer 425 may include a III-V material, such as GaN, and may be p-doped (e.g., with Mg, Ca, Zn, or Be) or n-doped (e.g., with Si or Ge). One or more active layers 435 may be grown on semiconductor layer 425. Active layer 435 may include III-V materials, such as one or more InGaN layers, one or more AlInGaP layers, and/or one or more GaN layers, which may form one or more heterostructures, such as one or more quantum wells. A semiconductor layer 445 may be grown on active layer 435. Semiconductor layer 445 may include a III-V material, such as GaN, and may be p-doped (e.g., with Mg, Ca, Zn, or Be) or n-doped (e.g., with Si or Ge). One of semiconductor layer 425 and semiconductor layer 445 may be a p-type layer and the other one may be an n-type layer.

To make contact with semiconductor layer 425 (e.g., an n-type GaN layer) and to more efficiently extract light emitted by active layer 435 from LED 405, the semiconductor layers may be etched to expose semiconductor layer 425 and to form a mesa structure that includes layers 425-445. The mesa structure may confine carriers within the injection area of the device. Etching the mesa structure may lead to the formation of mesa side walls (also referred to herein as facets) that may be non-parallel with, or in some cases, orthogonal, to the growth planes associated with crystalline growth of layers 425-445.

As shown in FIG. 4B, LED 405 may have a mesa structure that includes a flat top. A dielectric layer 475 (e.g., SiO₂ or SiN_{X}) may be formed on the facets of the mesa structure. In some embodiments, dielectric layer 475 may include multiple layers of dielectric materials. In some embodiments, a metal layer 495 may be formed on dielectric layer 475. Metal layer 495 may include one or more metal or metal alloy materials, such as aluminum (Al), silver (Ag), gold (Au), platinum (Pt), titanium (Ti), copper (Cu), or any combination thereof. Dielectric layer 475 and metal layer 495 may form a mesa reflector that can reflect light emitted by active layer 435 toward substrate 415. In some embodiments, the mesa reflector may be parabolic-shaped to act as a parabolic reflector that may at least partially collimate the emitted light.

Electrical contact 465 and electrical contact 485 may be formed on semiconductor layer 445 and semiconductor layer 425, respectively, to act as electrodes. Electrical contact 465 and electrical contact 485 may each include a conductive material, such as Al, Au, Pt, Ag, Ni, Ti, Cu, or any combination thereof (e.g., Ag/Pt/Au or Al/Ni/Au), and may act as the electrodes of LED 405. In the example shown in FIG. 4B, electrical contact 485 may be an n-contact, and electrical contact 465 may be a p-contact. Electrical contact 465 and semiconductor layer 445 (e.g., a p-type semiconductor layer) may form a back reflector for reflecting light emitted by active layer 435 back toward substrate 415. In some embodiments, electrical contact 465 and metal layer 495 include same material(s) and can be formed using the same processes. In some embodiments, an additional conductive layer (not shown) may be included as an intermediate conductive layer between the electrical contacts 465 and 485 and the semiconductor layers.

When a voltage is applied across contacts 465 and 485, electrons and holes may recombine in active layer 435. The recombination of electrons and holes may cause photon emission, thus producing light. The wavelength and energy of the emitted photons may depend on the energy bandgap between the valence band and the conduction band in active layer 435. For example, InGaN active layers may emit green or blue light, while AlInGaP active layers may emit red, orange, yellow, or green light. The emitted photons may propagate in many different directions, and may be reflected by the mesa reflector and/or the back reflector and may exit LED 405, for example, from the bottom side (e.g., substrate 415) shown in FIG. 4B. One or more other secondary optical components, such as a lens or a grating, may be formed on the light emission surface, such as substrate 415, to focus or collimate the emitted light and/or couple the emitted light into a waveguide.

One or two-dimensional arrays of the LEDs described above may be manufactured on a wafer to form light sources, and multiple light sources can be combined to form a display panel of a display system. The LED arrays can be controlled using driver circuits, which may be fabricated, for example, on a silicon wafer using CMOS processes. The LEDs and the driver circuits on wafers may be diced and then bonded together or bonded on the wafer level and then diced. Various bonding techniques can be used for bonding the LEDs and the driver circuits, such as adhesive bonding, metal-to-metal bonding, metal oxide bonding, wafer-to-wafer bonding, die-to-wafer bonding, hybrid bonding, and the like.

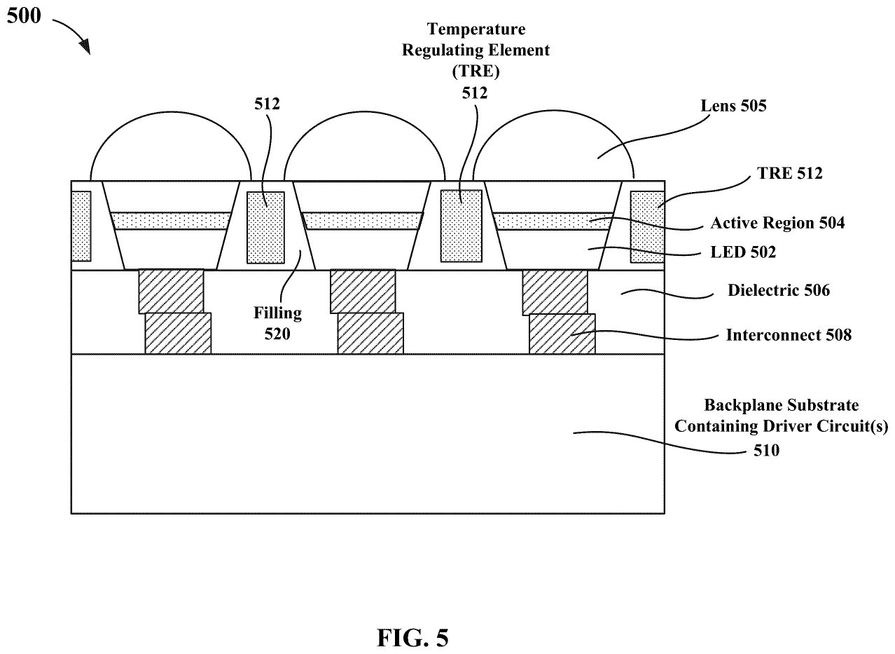

FIG. 5 illustrates an example of an LED device 500 with temperature regulating elements (TREs), according to certain embodiments. The LED device 500 includes multiple LEDs 502, which can be arranged in an array. Although not apparent from the cross-sectional view in FIG. 5, the LED array can be one-dimensional or multi-dimensional. For example, the LEDs 502 may be arranged according to a two-dimensional grid layout. For the sake of simplicity, the structure of the LEDs 502 is shown in less detail compared to the LEDs in FIGS. 4A and 4B. However, each LED 502 may include any of the LED features described herein. Other LED configurations are possible, and the LED structures disclosed herein should be taken as illustrative rather than limiting.

The LEDs 502 can be controlled by driver circuitry (not shown) located in a backplane substrate 510. In some embodiments, the LEDs 502 may be formed on a separate wafer that is subsequently bonded to a backplane wafer, through a wafer-to-wafer bond process or other bonding method. The LED device 500 includes a dielectric layer 506 between the LEDs 502 and the backplane substrate 510. Interconnects 508 may be formed in the dielectric layer 506 to provide electrical communication between the LEDs 502 and the circuitry in the backplane substrate 510. Additionally, the LED device 500 can include optical elements. In this example, each LED 502 has a corresponding lens 505 (e.g., a micro-lens) facing a light exit surface of the LED.

As shown in FIG. 5, TREs 512 can be formed in the spaces between adjacent LEDs. The TREs 512 can be formed before or after bonding the LED wafer to the backplane substrate 510. The space between LEDs is typically occupied by a filling 520, which can be the same or a different material than the dielectric layer 506. For example, the filling 520 can be formed of silicon nitride or silicon oxide. The material in the spaces between the LEDs is implementation dependent. In some cases, the filling 520 may even include metal. Regardless of the material(s) used for the filling 520, one option for the location of the TREs 512 is inside the filling 520. The TREs 512 can be formed by creating an opening or pocket in the filling 520 (e.g., through etching), introducing one or more phase change materials, and sealing the opening with a capping material (e.g., additional filling 520) after the PCM has been introduced. The PCM can be introduced in any state of matter (e.g., solid or liquid) that is compatible with the overall LED device manufacturing process. Thus, there can be different methods of incorporating PCM into the openings. For example, liquid PCM can be injected into the openings in the filling 520. As another example, each TRE 512 can be formed from a solid block of PCM and mechanically inserted into an opening.

Being located between LEDs 502, the TREs 512 are conveniently located to absorb heat generated by the LEDs, e.g., some or all of the heat originating from an active region 504. With enough heat absorbed, the TREs 512 will undergo phase transition (e.g., from solid to liquid) to convert the heat into stored energy. The PCM can be selected to have a transition temperature within an expected operating range of the LEDs. For example, the material composition of the PCM can be tuned to provide for phase transition at or near a desired/target operating temperature (e.g. somewhere between 50° to 60° Celsius). Each TRE 512 may be configured, e.g., based on shape, size, and/or material composition, to have a relatively large storage capacity. For example, a TRE 512 may be configured to be able to continuously absorb heat from one or more nearby LEDs 502 for at least half an hour. LED device 500 can be operated over longer durations, but in typical use, the LED device 500 would not be operated indefinitely without being turned off. For example, the LED device 500 may be configured to operate intermittently (e.g., on for half an hour, then off for half an hour). During the time that the LED device 500 is turned off, the LEDs 502 are no longer producing heat and will start to cool, which can trigger a reverse phase transition (e.g., liquid to solid) in the TREs 512. Gradual release of heat by the TREs 512 may offset or counterbalance the cooling of the LEDs 502, so that the internal temperature of the LED device 500 (e.g., the temperature at the active region 504) remains approximately the same as when the LEDs 502 were activated. After the reverse phase transition is complete, the process can be repeated in the opposite direction when the LED device 500 is once again turned on.

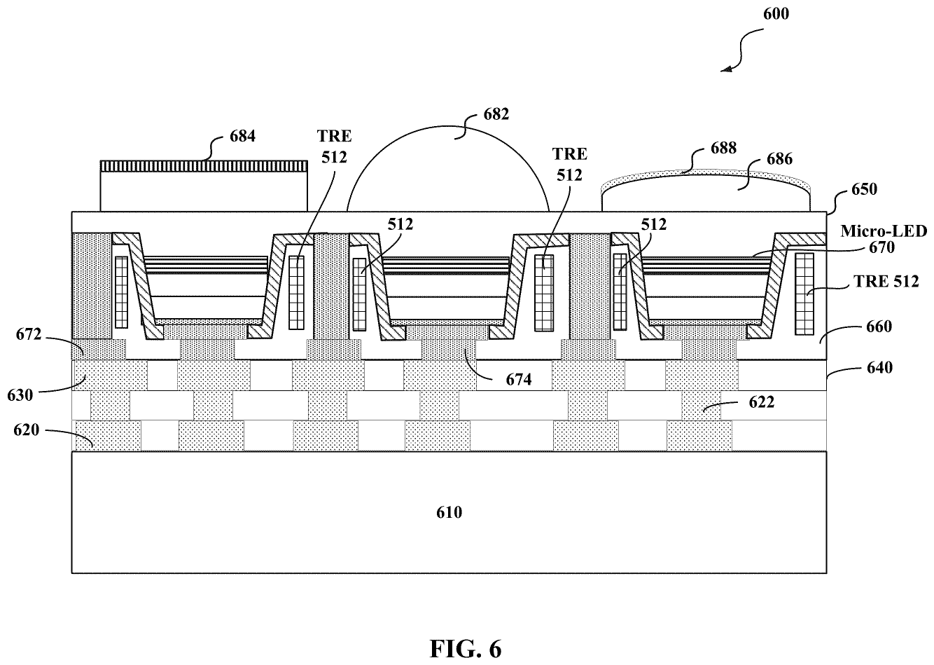

FIG. 6 illustrates another example of an LED device 600 with TREs, according to certain embodiments. In FIG. 6, the LED device 600 is depicted as having three different optical elements to show some examples of secondary optics, but this should not be taken to imply that different secondary optical components are used simultaneously for every LED device. Instead, as shown in FIG. 5, discussed above, each LED can have the same type of optical element (e.g., lens 505).

LED device 600 can include components similar to those discussed above with respect to the LED device 500. For instance, LED device 600 may include a substrate 610, which may be, for example, a silicon wafer. Integrated circuits 620, such as LED driver circuits, may be fabricated on substrate 610. Integrated circuits 620 may be connected to p-contacts 674 and n-contacts 672 of micro-LEDs 670 through interconnects 622 and contact pads 630, where contact pads 630 may form metallic bonds with p-contacts 674 and n-contacts 672. Dielectric layer 640 on substrate 610 may be bonded to dielectric layer 660 through fusion bonding.

The substrate (not shown) of the LED chip or wafer may be thinned or may be removed to expose the n-type layer 650 of micro-LEDs 670. Various secondary optical components, such as a spherical micro-lens 682, a grating 684, a micro-lens 686, an antireflection layer 688, and the like, may be formed in or on top of n-type layer 650. For example, spherical micro-lens arrays may be etched in the semiconductor materials of micro-LEDs 670 using a gray-scale mask and a photoresist with a linear response to exposure light, or using an etch mask formed by thermal reflowing of a patterned photoresist layer. The secondary optical components may also be etched in a dielectric layer deposited on n-type layer 650 using similar photolithographic techniques or other techniques. For example, micro-lens arrays may be formed in a polymer layer through thermal reflowing of the polymer layer that is patterned using a binary mask. The micro-lens arrays in the polymer layer may be used as the secondary optical components or may be used as the etch mask for transferring the profiles of the micro-lens arrays into a dielectric layer or a semiconductor layer. The dielectric layer may include, for example, SiCN, SiO₂, SiN, Al₂O₃, HfO₂, ZrO₂, Ta₂O₅, or the like. In some embodiments, a micro-LED 670 may have multiple corresponding secondary optical components, such as a micro-lens and an anti-reflection coating, a micro-lens etched in the semiconductor material and a micro-lens etched in a dielectric material layer, a micro-lens and a grating, a spherical lens and an aspherical lens, and the like.

The LED device 600 includes TREs 512 located between micro-LEDs 670, similar to the arrangement of TREs 512 in FIG. 5. As shown in FIG. 6, the TREs 512 can be positioned in occupied areas of the filling material (in this example, the dielectric 660). In particular, the TREs 512 can be placed in openings or pockets formed in the dielectric 660 and may be laterally offset from the n-contacts 672. FIG. 6 is provided merely as one example of an alternative arrangement of TREs.

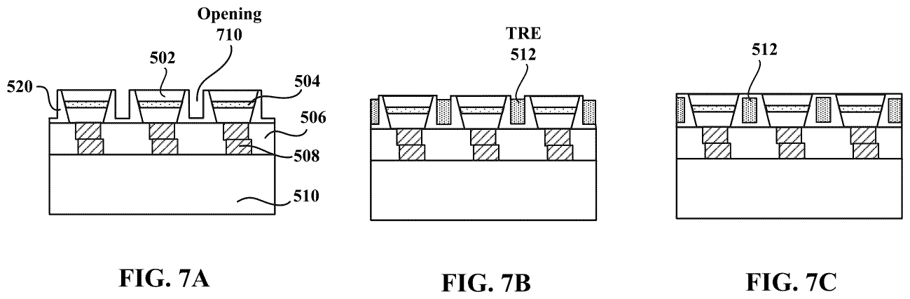

FIGS. 7A to 7C illustrate an example of a process for forming TREs in an LED device, according to certain embodiments. The example in FIGS. 7A-7C is described with respect to forming the LED device 500 of FIG. 5, but the techniques described can be applied to other display devices. In FIG. 7A, a semiconductor structure is being processed to form the LED device 500. At this time, the LED device 500 is mostly complete and includes an array of LEDs 502 that have been bonded to the backplane substrate 510. The filling 520 is etched (e.g., in a wet or dry etch step) to form openings 710.

In FIG. 7B, PCM is introduced into the openings 710 to form the TREs 512, which can partially or completely fill the openings 710. In this example, the TREs 512 are slightly recessed to leave space for sealing the openings 710. As shown in FIG. 7C, the openings 710 can be sealed with additional filling 520 to create a substantially flush surface. However, other capping materials can be used to seal the openings 710.

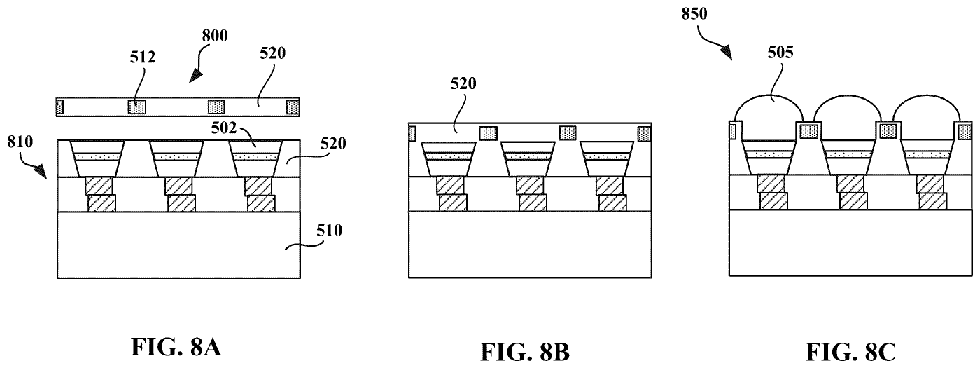

FIGS. 8A to 8C illustrate another example of a process for forming TREs in an LED device, according to certain embodiments. In this example, the TREs 512 are formed separately, on a carrier structure 800 containing filling 520. The carrier structure 800 is attached to a semiconductor structure 810 to form a single unit, shown in FIG. 8B. The carrier structure 800 can be attached through bonding, which may involve similar bonding methods as that used to bond the LED array to the backplane substrate 510.

The combined structure can be further processed, e.g., by etching the filling 520 to expose the LEDs 502 and add the lenses 505. The lenses 505 can be formed separately and attached or formed directly on the exposed surfaces. As shown in FIG. 8C, this would result in an LED device 850 similar to the LED device 500, except that the TREs 512 are now located slightly above (vertically offset from) the LEDs 502. Depending on the vertical distance, thermally conductive elements can also be added to facilitate heat transfer from the active regions of the LEDs 502 to the TREs 512. However, additional conductive elements may not be needed at a micro-LED scale.

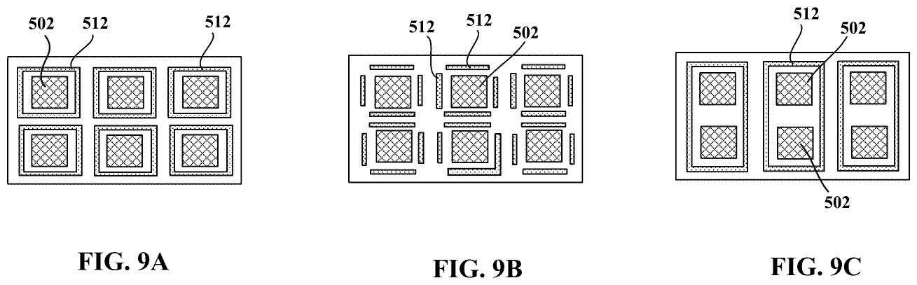

FIGS. 9A to 9C illustrate examples of different ways in which TREs may be arranged, according to certain embodiments. In FIG. 9A, the TREs 512 are shaped to surround the entire perimeter of each LED 502 (e.g., with a square or rectangular cross-section). In FIG. 9B, the LEDs 502 are partially surrounded by the TREs 512, which form discontinuous segments around the perimeter of each LED. FIG. 9C is similar to FIG. 9A, except that a single TRE 512 now surrounds multiple LEDs 502 (in this example, two LEDs).

In some embodiments, a method of forming a display apparatus includes forming a plurality of light emitters from a semiconductor structure. The semiconductor structure can include multiple layers of semiconductor materials that are patterned into mesas corresponding to individual light emitters. The light emitters are spaced apart and may be separated by a filling layer. The method further includes depositing at least one TRE between adjacent light emitters. The at least TRE can be deposited before or after bonding the semiconductor structure to a backplane substrate containing one or more driver circuits (e.g., backplane substrate 510).

According to the example of FIGS. 7A to 7C, depositing the at least one TRE may involve forming openings between adjacent light emitters followed by filling the openings with phase change material. The openings can be formed around the perimeter of individual light emitters to define channels conforming to the desired shapes of the TREs (e.g., according to one of the layouts shown in FIGS. 9A to 9C). Once the phase change material is deposited, the openings can be sealed (e.g., with the same material as the filling layer).

Alternatively, as discussed above with reference to FIGS. 8A to 8C, the least one TRE may be formed on a carrier structure. In that case, depositing the at least one TRE may involve aligning and bonding the carrier structure to an emitter facing side of the semiconductor structure. The carrier structure may be aligned such that the at least one TRE is centered between the adjacent light emitters. The method may optionally include forming one or more optical elements (e.g., lenses 505) on a light exit surface of the light emitters after the phase change material has been deposited. Depending on the way in which the phase change material was deposited, the semiconductor structure may be further processed to expose the light exit surface (e.g., etching away some of the filling 520 in FIG. 8B).

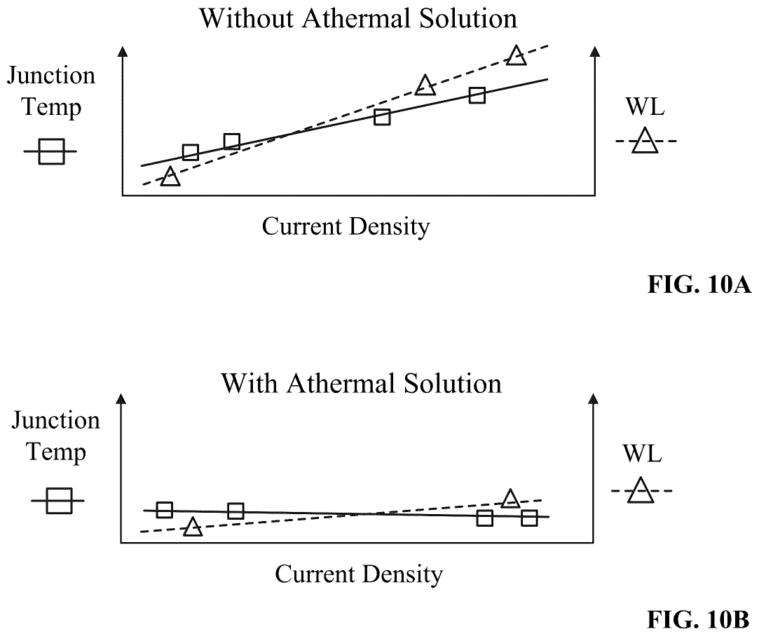

FIG. 10A is a graph of junction temperature and wavelength in the absence of thermal management. As indicated in the graph, wavelength (WL) and junction temperature increase significantly with increasing operating current (current density).

FIG. 10B is a graph of junction temperature and wavelength after applying the thermal management techniques disclosed herein. In particular, the graph in FIG. 10B may represent a result of incorporated PCM based temperature regulating elements into a display device. FIG. 10B shows that junction temperature can be maintained at a substantially constant level, while wavelength may only experience a slight increase as the current density increases.

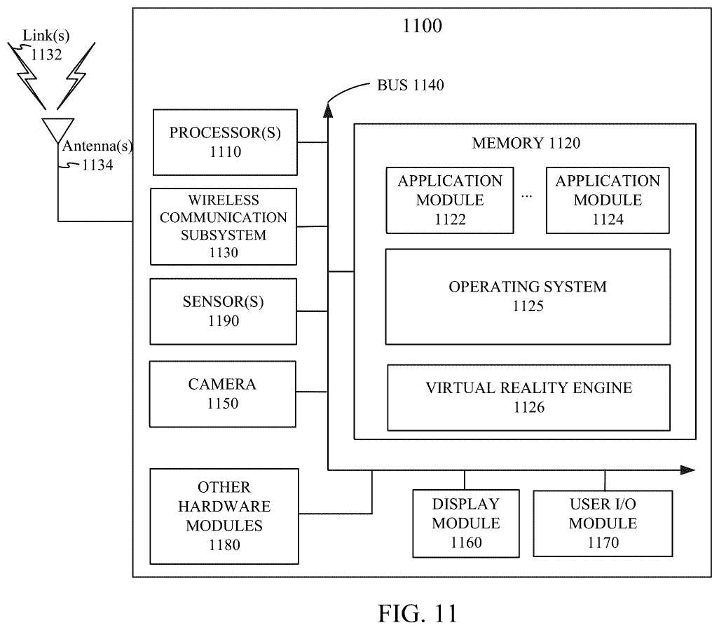

FIG. 11 is a simplified block diagram of an example of an electronic system 1100 of a near-eye display system (e.g., HMD device) for implementing some of the examples disclosed herein. Electronic system 1100 may be used as the electronic system of an HMD device or other near-eye displays described above. In this example, electronic system 1100 may include one or more processor(s) 1110 and a memory 1120. Processor(s) 1110 may be configured to execute instructions for performing operations at a number of components, and can be, for example, a general-purpose processor or microprocessor suitable for implementation within a portable electronic device. Processor(s) 1110 may be communicatively coupled with a plurality of components within electronic system 1100. To realize this communicative coupling, processor(s) 1110 may communicate with the other illustrated components across a bus 1140. Bus 1140 may be any subsystem adapted to transfer data within electronic system 1100. Bus 1140 may include a plurality of computer buses and additional circuitry to transfer data.

Memory 1120 may be coupled to processor(s) 1110. In some embodiments, memory 1120 may offer both short-term and long-term storage and may be divided into several units. Memory 1120 may be volatile, such as static random access memory (SRAM) and/or dynamic random access memory (DRAM) and/or non-volatile, such as read-only memory (ROM), flash memory, and the like. Furthermore, memory 1120 may include removable storage devices, such as secure digital (SD) cards. Memory 1120 may provide storage of computer-readable instructions, data structures, program modules, and other data for electronic system 1100. In some embodiments, memory 1120 may be distributed into different hardware modules. A set of instructions and/or code might be stored on memory 1120. The instructions might take the form of executable code that may be executable by electronic system 1100, and/or might take the form of source and/or installable code, which, upon compilation and/or installation on electronic system 1100 (e.g., using any of a variety of generally available compilers, installation programs, compression/decompression utilities, etc.), may take the form of executable code.

In some embodiments, memory 1120 may store a plurality of application modules 1122 through 1124, which may include any number of applications. Examples of applications may include gaming applications, conferencing applications, video playback applications, or other suitable applications. The applications may include a depth sensing function or eye tracking function. Application modules 1122-1124 may include particular instructions to be executed by processor(s) 1110. In some embodiments, certain applications or parts of application modules 1122-1124 may be executable by other hardware modules 1180. In certain embodiments, memory 1120 may additionally include secure memory, which may include additional security controls to prevent copying or other unauthorized access to secure information.

In some embodiments, memory 1120 may include an operating system 1125 loaded therein. Operating system 1125 may be operable to initiate the execution of the instructions provided by application modules 1122-1124 and/or manage other hardware modules 1180 as well as interfaces with a wireless communication subsystem 1130 which may include one or more wireless transceivers. Operating system 1125 may be adapted to perform other operations across the components of electronic system 1100 including threading, resource management, data storage control and other similar functionality.

Wireless communication subsystem 1130 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1100 may include one or more antennas 1134 for wireless communication as part of wireless communication subsystem 1130 or as a separate component coupled to any portion of the system. Depending on desired functionality, wireless communication subsystem 1130 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1130 may permit data to be exchanged with a network, other computer systems, and/or any other devices described herein. Wireless communication subsystem 1130 may include a means for transmitting or receiving data, such as identifiers of HMD devices, position data, a geographic map, a heat map, photos, or videos, using antenna(s) 1134 and wireless link(s) 1132. Wireless communication subsystem 1130, processor(s) 1110, and memory 1120 may together comprise at least a part of one or more of a means for performing some functions disclosed herein.

Embodiments of electronic system 1100 may also include one or more sensors 1190. Sensor(s) 1190 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 1190 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 1100 may include a display module 1160. Display module 1160 may be a near-eye display, and may graphically present information, such as images, videos, and various instructions, from electronic system 1100 to a user. Such information may be derived from one or more application modules 1122-1124, virtual reality engine 1126, one or more other hardware modules 1180, a combination thereof, or any other suitable means for resolving graphical content for the user (e.g., by operating system 1125). Display module 1160 may use liquid crystal display (LCD) technology, light-emitting diode (LED) technology (including, for example, OLED, ILED, micro-LED, AMOLED, TOLED, etc.), light emitting polymer display (LPD) technology, or some other display technology.

Electronic system 1100 may include a user input/output module 1170. User input/output module 1170 may allow a user to send action requests to electronic system 1100. An action request may be a request to perform a particular action. For example, an action request may be to start or end an application or to perform a particular action within the application. User input/output module 1170 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1100. In some embodiments, user input/output module 1170 may provide haptic feedback to the user in accordance with instructions received from electronic system 1100. For example, the haptic feedback may be provided when an action request is received or has been performed.

Electronic system 1100 may include a camera 1150 that may be used to take photos or videos of a user, for example, for tracking the user's eye position. Camera 1150 may also be used to take photos or videos of the environment, for example, for VR, AR, or MR applications. Camera 1150 may include, for example, a complementary metal-oxide-semiconductor (CMOS) image sensor with a few millions or tens of millions of pixels. In some implementations, camera 1150 may include two or more cameras that may be used to capture 3-D images.

In some embodiments, electronic system 1100 may include a plurality of other hardware modules 1180. Each of other hardware modules 1180 may be a physical module within electronic system 1100. While each of other hardware modules 1180 may be permanently configured as a structure, some of other hardware modules 1180 may be temporarily configured to perform specific functions or temporarily activated. Examples of other hardware modules 1180 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 1180 may be implemented in software.

In some embodiments, memory 1120 of electronic system 1100 may also store a virtual reality engine 1126. Virtual reality engine 1126 may execute applications within electronic system 1100 and receive position information, acceleration information, velocity information, predicted future positions, or some combination thereof of the HMD device from the various sensors. In some embodiments, the information received by virtual reality engine 1126 may be used for producing a signal (e.g., display instructions) to display module 1160. For example, if the received information indicates that the user has looked to the left, virtual reality engine 1126 may generate content for the HMD device that mirrors the user's movement in a virtual environment. Additionally, virtual reality engine 1126 may perform an action within an application in response to an action request received from user input/output module 1170 and provide feedback to the user. The provided feedback may be visual, audible, or haptic feedback. In some implementations, processor(s) 1110 may include one or more GPUs that may execute virtual reality engine 1126.

In various implementations, the above-described hardware and modules may be implemented on a single device or on multiple devices that can communicate with one another using wired or wireless connections. For example, in some implementations, some components or modules, such as GPUs, virtual reality engine 1126, and applications (e.g., tracking application), may be implemented on a console separate from the head-mounted display device. In some implementations, one console may be connected to or support more than one HMD.

In alternative configurations, different and/or additional components may be included in electronic system 1100. Similarly, functionality of one or more of the components can be distributed among the components in a manner different from the manner described above. F or example, in some embodiments, electronic system 1100 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, and the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto. Thus, although specific embodiments have been described, these are not intended to be limiting.

What is claimed is:

1. An apparatus comprising:
a semiconductor structure having a plurality of light emitters formed therefrom, each light emitter comprising an active region configured to emit light; and
at least one temperature regulating element (TRE) in the semiconductor structure, wherein each TRE comprises a phase change material configured to undergo a phase transition from a first state of matter to a second state of matter in response to heat, such that at least some of the heat is expended in causing the phase transition instead of heating an area around the TRE.

2. The apparatus of claim 1, wherein the at least one TRE comprises a first TRE between a first light emitter and a second light emitter.

3. The apparatus of claim 2, wherein the semiconductor structure comprises a filling layer occupying spaces between adjacent light emitters, and wherein the first TRE is located inside the filling layer.

4. The apparatus of claim 2, wherein the first TRE is spaced apart from the first light emitter and the second light emitter and at least partially surrounds a perimeter of the first light emitter.

5. The apparatus of claim 4, wherein the first TRE fully surrounds the perimeter of the first light emitter.

6. The apparatus of claim 4, wherein the first TRE surrounds the first light emitter and a third light emitter, the third light emitter being adjacent to both the first light emitter and the second light emitter.

7. The apparatus of claim 1, wherein the phase transition is from solid to liquid.

8. The apparatus of claim 1, wherein the phase transition is from liquid to solid.

9. The apparatus of claim 1, wherein the phase change material has a transition temperature within an expected operating temperature range of the plurality of light emitters.

10. The apparatus of claim 9, wherein the transition temperature is between 50° to 60° Celsius.

11. The apparatus of claim 1, wherein the phase change material is further configured to undergo a reverse phase transition from the second state of matter back to the first state of matter in response to cooling.

12. The apparatus of claim 11, wherein the heat causing the phase transition originates at least in part from the active region of one or more light emitters that are activated, and wherein the cooling results from deactivating the one or more light emitters.

13. The apparatus of claim 11, wherein the phase change material is configured to release heat during the reverse phase transition.

14. The apparatus of claim 1, wherein the at least one TRE is configured to undergo the phase transition over at least half an hour of continuous operation of the plurality of light emitters.

15. A display system comprising:
a light emitting diode (LED) array including a plurality of LEDs formed from a semiconductor structure, wherein the semiconductor structure comprises an active layer corresponding to a light emitting region of each LED;
a driver circuit configured to control the LED array using electrical signals communicated through the semiconductor structure; and
at least one temperature regulating element (TRE) in the semiconductor structure, wherein each TRE comprises a phase change material configured to undergo a phase transition from a first state of matter to a second state of matter in response to heat, such that at least some of the heat is expended in causing the phase transition instead of heating an area around the TRE, and wherein the heat causing the phase transition originates at least in part from the light emitting region of one or more LEDs that are activated by the driver circuit.

16. The display system of claim 15, wherein the at least one TRE comprises a first TRE between a first LED and a second LED.

17. The display system of claim 16, wherein the first TRE is spaced apart from the first LED and the second LED and at least partially surrounds a perimeter of the first LED.

18. The display system of claim 16, wherein the first TRE starts solid and transitions to liquid in response to the heat.

19. The display system of claim 16, wherein the first TRE starts liquid and transitions to solid in response to the heat.

20. The display system of claim 15, wherein the phase change material is further configured to undergo a reverse phase transition from the second state of matter back to the first state of matter in response to cooling, and wherein the cooling is a result of the driver circuit deactivating the one or more LEDs.
